(19) United States
(12) Patent Application Publication
(10) Pub. No.: US 2014/0303922 A1
(43) Pub. Date: Oct. 9, 2014

(54) Integrated Tool for Compliance Testing

(71) Applicant: Agilent Technologies, Inc., Loveland, CO (US)

(72) Inventor: Charles T. Manfredi, Oakhurst, NJ (US)

(73) Assignee: Agilent Technologies, Inc., Loveland, CO (US)

(21) Appl. No.: 14/257,837

(22) Filed: Apr. 21, 2014

Related U.S. Application Data
(63) Continuation-in-part of application No. 12/150,030, filed on Apr. 24, 2008.

(51) Int. Cl. G01M 99/00; G01D 18/00

(52) U.S. Cl. CPC G01M 99/00; G01D 18/00
USPC 702/85

(57) ABSTRACT

A method for operating a data processing system to perform compliance testing of an instrument system is disclosed. The instrument system includes an underlying instrument and a computerized data system (CDS) that controls the underlying instrument. The method includes causing data indicative of a measurement made on a test sample by the underlying instrument to be received by the data processing system. The data processing system then performs data reduction computations on the received data while the received data is in a technology neutral format using the data processing system to generate one or more outputs in a technology neutral format. A final report in a technology neutral format is then generated with the one or more outputs. The data processing system can be separate from the CDS or a program that runs under the CDS.

### RELATED APPLICATIONS

This application is a continuation-in-part of U.S. patent application Ser. No. 12/150,030 filed on Apr. 24, 2008, which is a continuation of U.S. patent application Ser. No. 11/119,255, filed on Apr. 29, 2005, now U.S. Pat. No. 7,440,863. The contents of all of both of these related applications being incorporated herein in their entirety by reference.

### BACKGROUND

Modern instruments are often synthesized from hardware components sold by one manufacturer and controllers provided by a second manufacturer who sells the instrument. For example, a number of gas chromatography systems for measuring the properties of a gaseous sample are constructed from a hardware component consisting of a gas chromatography system that includes an injector for introducing samples into the instrument, the separation column, and final sensor that measures the material that passes the sensor. A commercial system includes a controller that operates the hardware component and collects the data generated thereby. For, example, the controller operates the injector to initiate the measurement of a sample, controls the environment of the separation column, and records the output of the sensor as a function of time as well as the operating parameters of the gas chromatography system. To simplify the following discussion, the hardware component will be referred to as the “underlying instrument”.

Several commercial systems made and marketed by different companies are often based on the same underlying instrument that is manufactured by a different company. The different systems can have different controllers. The controllers typically use proprietary software that accepts a test protocol and generates data in a native format that maybe different from system to system. In some systems, the manufacturer translates the measurement data to a “technology neutral” format that is independent of the particular instrument system.

The operation of the underlying instrument must be periodically verified in many systems to ensure that the instrument is functioning as designed. For example, one class of instrument systems must operate in regulated markets in which the systems' performance must be periodically measured and certified to be in compliance with standards set by entities other than the instrument manufacturer. These systems must provide an audit trail that can be used to show that the instrument was performing correctly when the instrument was used for a specific test. In a legal setting, the user of the instrument must also be able to demonstrate that the data from the periodic certifications has not been altered. Hence, certification by independent third parties is preferred. Ideally, the system would generate a human readable report that would allow the auditor to judge the performance of the system by providing measured values obtained in predetermined test procedures and allowed ranges for those measured values.

Systems based on embedding qualification software in the native controllers of the instruments are known. However, such solutions have two problems. First, they require that every controller include the embedded software, which increases the cost of the system. Second, the results depend on the qualifying software in the embedded software, and hence, can differ from instrument system to instrument system because different algorithms are used in different software embodiments.

Other systems for qualifying the underlying instrument can require that a separate controller be connected to the underlying instrument to generate the qualification data. Such a controller can utilize its own analog-to-digital converters for collecting sensor data and other interfaces for running the various functions of the underlying instrument. In addition to increasing the cost and complexity of the qualification function, the tests do not measure the function of the underlying instrument when controlled by its normal controller.

### BRIEF DESCRIPTION OF THE DRAWINGS

FIG. 1 shows a flow chart of events that may be carried out during processing according to at least one embodiment of the present invention.

FIG. 2 illustrates one example of a form that may be used by an embodiment of the present invention.

FIG. 3 is a schematic flow chart illustrating process flow according to an embodiment of the present invention.

FIG. 4 is a block diagram illustrating functions and processes that may be managed through a business process manager according to an embodiment of the present invention.

FIG. 5 illustrates the extraction of information from a form.

FIG. 6 is a flow chart illustrating further details of process flow by an embodiment of the present invention.

FIG. 7 is a schematic representation of an embodiment of a system for use in creating a compliance report for chromatographic instrumentation.

### SUMMARY

The present invention includes a method for operating a data processing system to perform compliance testing of an instrument system. The instrument system includes an underlying instrument and a computerized data system (CDS) that controls the underlying instrument. The method includes causing data indicative of a measurement made on a test sample by the underlying instrument to be received by the data processing system. The data processing system then performs data reduction computations on the received data while the received data is in a technology neutral format using the data processing system to generate one or more outputs in a technology neutral format. A final report in a technology neutral format is then generated with the one or more outputs. The data processing system can be separate from the CDS or a program that runs under the CDS.

In one aspect of the invention, the received data is received in a native format and converted to the technology neutral format by the data processing system before the data reduction computations are performed. Alternatively, the CDS can convert the data indicative of the measurement to a technology neutral format prior to the data indicative of the measurement being received by the data processing system.

In another aspect of the invention, the data processing system can operate the underlying instrument to make the measurement without utilizing the CDS to make the measurement.

In a still further aspect of the invention, the final report includes security features that prevent the final report from being altered after the final report is approved by a predetermined entity. In one embodiment, the report establishes compliance with a standard promulgated by a governmental regulatory agency. To further establish the creditability of the report, the data processing system is provided by an entity that is different from the entity that owns the instrument system.

### DETAILED DESCRIPTION

Before the present systems, methods and computer readable media are described; it is to be understood that this invention is not limited to the particular hardware, software, or media described, as such may, of course, vary. It is also to be understood that with the exception of terms that have a stated definition, the terminology used herein is for the purpose of describing particular embodiments only, and is not intended to be limiting.

It must be noted that as used herein and in the appended claims, the singular forms “a”, “and”, and “the” include plural referents unless the context clearly dictates otherwise. Thus, for example, reference to “a form” includes a plurality of such forms and reference to “the analytical instrument” includes reference to one or more analytical instruments and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

An “underlying instrument” is defined to be a hardware component that makes measurements on a physical sample and generates data indicative of one or more properties of that sample. Exemplary underlying instruments are chromatographs, mass spectrometers, microscopes, etc. Hardware components that make measurements or characterize computer systems or computer networks are not underlying instruments as used herein.

An “instrument system” is defined to be an underlying instrument that is controlled by a CDS that causes that underlying instrument to perform measurements on a sample in response to commands thereto and reports the results of those measurements.

A “native format” is defined to be the data format used within the CDS for data derived from the underlying instrument. For example, if the underlying instrument includes a sensor whose output is measured as a function of time, the list of (time, sensor value) measurement data derived by CDS as those measurements are recorded within the CDS would be data in a native format.

A “technology neutral format” is defined to be a format in which test results are communicated between the measurement system and other entities that use the data generated by measurement system. The format is independent of the manufacturer of the system or model of the system such that test data from different manufacturers or models can be read and understood by an entity that is not privy to the native data format utilized by the manufacturer's controller. The test data values must be comparable to predetermined ranges of allowed values and comparable to values generated by different manufacturers using the same underlying instrument.

A “platform” as used herein refers to a support infrastructure for acceptance and coordination of tools and applications required to perform a series of related, but diverse tasks.

An “enterprise content manager” (ECM) refers to a system, scalable to enterprise levels, composed of various hardware and software elements that support the secure collection, indexing and storage of electronic objects.

A “technology neutral format” is defined to be a data format that stores measurement values in a format that is independent of the manufacturer and model of the instrument system that generated the data. The technology neutral format allows a party that is not familiar with the manufacturer and model of the instrument system to read and understand the measurement data in the technology neutral format without a knowledge of the data format used within a file containing that data. That is, a third party can compare measurements made by two different instrument systems from different manufacturers to determine if the measurements are within a predetermined set of parameters as required by a compliance standard. In addition, the measurements extracted from a technology neutral format can be used to make computations that depend on the measurements. The format includes identification of the measurements stored therein and the units for the data values. The format also includes identification of the underlying instrument type.

For example, in the case of a gas chromatography system, a measurement typically includes data from a detector in which the amplitude of the detector signal as a function of time is presented as a series of (time, amplitude) measurements. A technology neutral format file for this data includes information indicating that the instrument is a gas chromatography system. The measurements in the file would be labeled such that a program that understands the technology neutral format could determine that the data consists of time, amplitude values in which time is measured in seconds and amplitude is measured in volts from a detector. Any gas chromatography system constructed from the underlying instrument would generate a file having the same data, and this file could be read by a third party's processing program independent of the gas chromatography system in question. The technology neutral format for gas chromatograph systems would be readable by such third party data processing programs independent of the make and model of the underlying gas chromatography instrument. For example, the third party systems could measure the area under one of the peaks in the time-amplitude data pairs and compare that area with areas computed from corresponding peaks in other technology neutral formatted files or the requirements of a relevant compliance standard. One non-limiting example of a technology neutral format that may be employed by the present system is referred to as Analytical Information Markup Language (AnIML) which is an open source, XML-based standard for formatting analytical data.

Disclosed herein are methods, systems and computer readable media for processing data outputted by analytical instruments in a standardized manner so that results of processing are directly comparable with results from processing data outputted by other instruments, regardless of model or manufacturer. These results can be automatically processed to provide compliance validation reports or other reports indicative of the underlying instrument or system's performance.

Calculations may be performed to answer a series of questions relating to one or more performance tests designed to determine compliance of an analytical instrument and/or software under consideration with a set of predefined criteria. Such predefined criteria may be criteria defined for regulated industries. For example, “predefined criteria” include, but are not limited to regulations set forth in the Food, Drug, and Cosmetic Act. Predefined criteria are limits and criteria that represent best practices and manufacturers' specifications relating to instrument operation and performance. Compliance to these acceptance criteria provides documented evidence of a device's operation within expectation of intended use. Such compliance may be required by law and listed in the Code of Federal Regulations under headings Part 210, 211, 820, 58, and 21-Part 11 as well as other such regulations and guidance as applies.

Forms may be used as built-in records to store data as it occurs to provide tracking/audit trails. The forms are further useable as a basis for generating reports in a variety of formats. However, as reports are changed, the underlying processes (e.g., the forms containing the data from which the reports are generated) stay the same. Basic universal forms stay the same, while the data they contain can be used to report in many different ways. The forms may be provided to a user in a “wizard-type” interface in which the user is prompted for simple tasks, the responses to which are incorporated into a much larger data product.

An ECM may be employed to provide a secure platform to manage all data storage, the extraction of metadata, and archiving of the data. One non-limiting example of an ECM that may be employed is a Cerity ECM of Agilent Technologies, Inc. Since an ECM is an enterprise system, it also provides scalability to the present system.

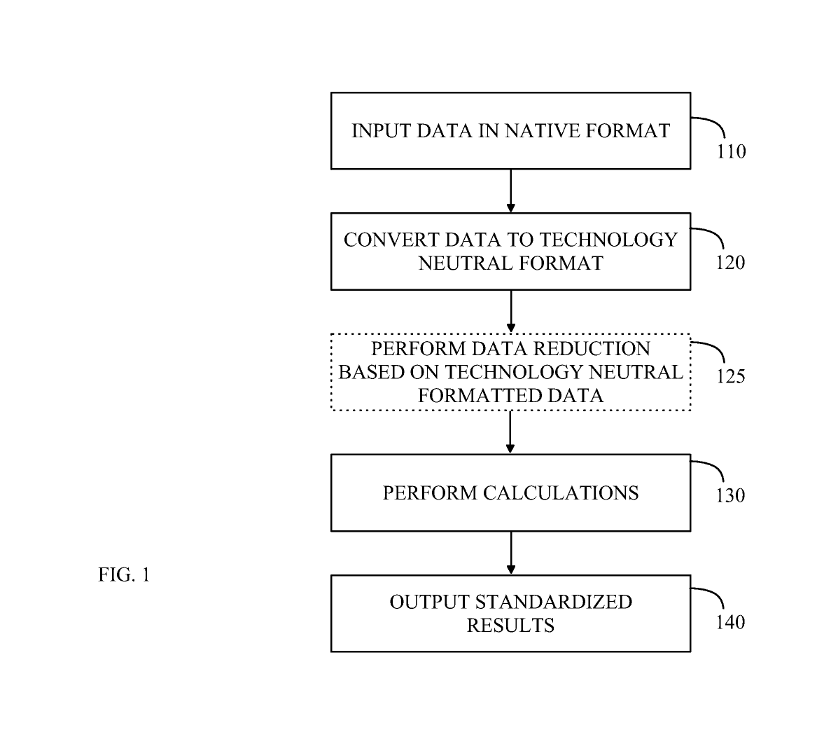

Referring to FIG. 1, data is inputted to one embodiment of a system according to the present invention in its native format at event 110, for initial conversion to a technology neutral format (event 120). All further processing of the data is then independent of the native data format. The data can be generated by an instrument system in response to a set of commands that cause the instrument system to operate the underlying instrument and collect data in the native data format that is used by the instrument system. The data can be converted to the technology neutral format either in the instrument system or by a data processing system according to the present invention.

Any required data reduction may be performed at event 125 by a data reduction engine according to the present invention. The data reduction engine could be part of the instrument system or part of a data reduction platform as described below. By performing calculations/further processing (event 130) on technology neutral formatted data with the present system, results (event 140) are directly comparable between data produced by various instruments, models and manufacturers. Furthermore, the same standardized data reduction software can be used for different instrument systems without revealing the underlying proprietary data formats used within the instrument systems. By converting all data to a technology neutral format, and then processing the converted data all according to the same protocols, results are generated that are standardized and directly comparable among results for different instruments which may be different models and/or made by different manufacturers.

As noted, the CDS that is in place for operating the instrument to obtain the data on which a report is to be generated may be used as direct input to the system of the present invention. Thus, original data collected for a report may be accomplished using the native controlling software of the CDS without the need to go through external analog-to-digital conversion or other manipulation of the underlying instrument to provide the qualification data. In many cases, the CDS is being run on a general purpose data processing system that has an operating system that allows additional programs to run on that data processing system. A data reduction and reporting program according to the present invention may be incorporated in the CDS or may be provided by qualification personnel who run the qualification tests.

When the qualification tests are being run to meet regulatory or legal requirements, it is advantageous to have third party personnel who are independent of the instrument system's owner perform the tests. In one aspect of the present invention, the qualification personnel load a reporting program according to the present invention on the CDS and run the CDS to provide the test data. The personnel then point the reporting program to the location of the test data that is output by the CDS. If that test data is already in a technology neutral format, the reporting program performs the necessary computations on that data and generates the required reports. If the data is not in a technology neutral format, the reporting program can include a specific translation program for converting the data in the native format to a technology neutral format prior to performing the computations.

Original data, which may be preserved for possible reanalysis by the native CDS, is also converted to an accepted technology neutral format allowing the data to be submitted to a single reprocess and calculation engine for consistent reduction and processing. By using the native CDS, the present system may also make use of the drivers employed by the native CDS, thereby further facilitating the universal applicability of the present system to different types of instruments and to instruments having different standards/CDS s as a result of being produced by different manufacturers.

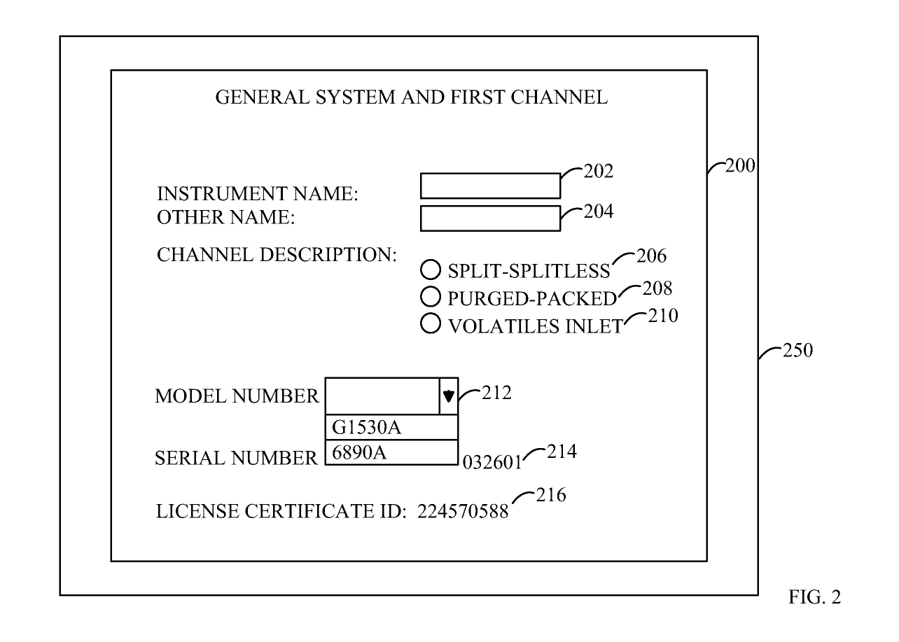

Instructions may be instantiated as one or more forms that provide a format for inputting data and a data repository. Refer now to FIG. 2, which illustrates one such form. The instrument/process type as well as the required input to the form 200 dictates some of the content and appearance of form 200. Form 200 includes fields instructing the following data to be inserted and stored: Instrument Name 202, Other Name 204, Channel Description: Split-Splitless 206, Purged-Packed 208, Volatiles Inlet 210, Model Number 212, Serial Number 214, and License Certificate ID 216. In some cases, some or all of the data fields can be automatically identified from the technology neutral formatted data and/or native CDS and populated into form 200 without requiring operator input.

In cases in which automatic population of all required data is not possible, user interface 250 can display form 200 to allow the user to interactively select an entry. For example, Model Number 212 can be provided by a drop down menu or other user interaction. User interface 250 may optionally be used to enter all data required by a form.

A user interface may also display a test protocol that prompts the user to input information regarding results of a test. In some instances, the test may be automated, wherein the system may prompt one or more lab instruments to initiate a test protocol in response to one or more answers inputted into the user interface by the user in response to questions asked on an interactive form/test protocol, or in response to results from another instrument (e.g., in response to a test protocol designed for that instrument). The system may also provide a report detailing processes and/or instruments that do not comply with selected specifications (i.e., a protocol deviation form).

The forms may be XML based forms that can be directly rendered to a final report (such as in PDF format, or other format suitable for paper documents, for example). Thus, for example, forms 200 may be displayed in PDF or some other document format on user interface 250 when part or all of them are to be interactively filled out by a user. Part or all of forms 200 may be programmatically filled out from auto-detection of calculation engines provided by the system. Forms 200 may be left in native XML format and thereby function as storage for the data that they contain. Forms 200 may be further rendered from the XML format to an HTML version for use with a browser.

By converting proprietary data into standardized data (i.e., data having a technology neutral format), the system may provide data in a standardized output form. Thus, inconsistent output from different instruments can be converted to consistent input to an engine that can do calculations in a standardized manner, which is an important consideration for qualification and compliance reports.

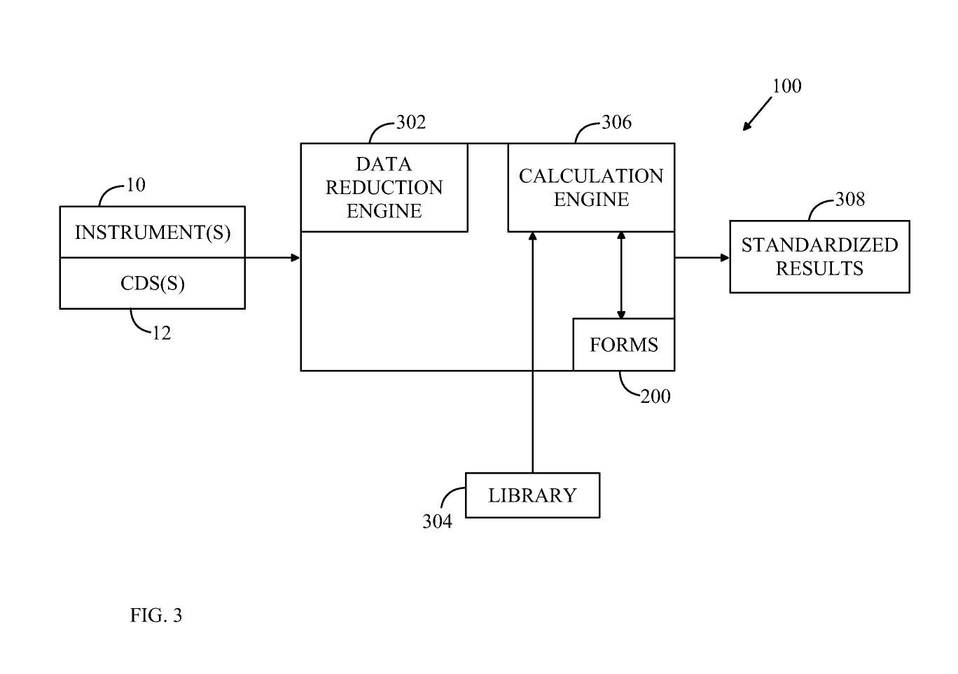

Refer now to FIG. 3. Once the native data has been converted into technology neutral formatted data, metadata may be created by data reduction engine 302 of the system 100 so that algorithms from the system(s) of instrument 10 do not need to be relied upon to further ensure standardization of results. The conversion of the native data to technology neutral formatted data can be performed in CDS 12 or by a component of system 100. For example, for application to chromatography, the present system does not rely upon the software running the chromatography instrument 10 from which the raw data is generated to determine what is a peak in the data or where to define the location of that peak, as such determinations are made based upon calculations and algorithms run by the data reduction engine 302 of the present system. Data reduction engine 302 reads the data having been converted into technology neutral formatted data and converts this digital representation of an analog function into data representing features that are described/characterized by the data (e.g., peaks, noise, gradient steps, etc.). The same applies to other calculations, such as those determining and/or filtering noise levels, etc. Using this approach, consistent results are determined for data independent of the manufacturer or model of instrument 10.

As one example, signal data from a chromatography instrument inputted to system 100 by the native controlling software for the instrument is just a series of changing signals over time. Data reduction engine 302 converts these signals (having been converted to a technology neutral format) into useable data, e.g., peak area, noise calculations, etc., which can be fed to calculation engine 306 that determines the characteristics of the data, such as the number of peaks, the area of each peak, and the location of each peak. In addition, the statistical accuracy of these calculated quantities can be ascertained so that these values can be compared to an acceptance standard, or with like values calculated with regard to another instrument.

Depending upon the instrument that has generated the data, a data reduction engine 302 may not even be needed. For example, a balance already outputs data that is reduced to numbers that are useable by calculation engine 306; hence, this data does not need to be further reduced, although it may need to be converted to a technology neutral format. Further, other alternative data reduction engines 302 may be included with the system 100 as part of a library 304 that may be accessed for non-standard reduction requirements. By performing data reduction with a component of system 100, the results do not rely on each instrument's software for performing such functions. Hence, the standardized results 308 are more reliable, since these results do not depend on computational software in the native instrument.

Further, since the data is in a standardized technology neutral format, only one method needs to be developed to produce a particular type of report based on the data, as opposed to the current need to create a method for each instrument that employs a different data type or format. Thus, calculation engine 306 can perform calculations based upon a single library 304 (e.g., a series of calculations tailored to a specific type of report for a particular type of data reporting). Thus although the method for acquisition of data may vary depending upon the CDS from which the data is being acquired, once that data has been converted to a technology neutral format, the processing by the data reduction and calculation engines will be consistent. Library 304 typically contains a set of calculations for performance of the standardized tasks in this processing (e.g., calculation/identification of peaks; calculation of statistics describing the data, etc.). With respect to data reduction and calculation, the results may be standardized and independent of the originating data system or controlled instrument, provided the underlying instruments belong to the same class of instruments. Reports based on those results are fully customizable, as reports ranging from simple summary reports to traditional, fully described compliance protocols may be outputted.

Since the algorithms in library 304 utilized data in a technology neutral format, the algorithms do not have to be specific for each CDS. For example, a library may be created to calculate peak precision, signal-to-noise, etc., and library 304 does not have to take into account differences in how the input data is represented in the CDSs of various instrument systems that use the same type of underlying instrument. Furthermore, some computations, such as peak detection and characterization, apply to different classes of underlying instruments. Hence, these computations can be applied across all manufacturers, types and models of instrumentation.

As noted above, forms according to the present invention may act as instructions for processes carried out by the calculation engine, as well as for data storage repositories of the results of these calculations. The forms can contain any combination of input types including interactive manual input, information detected by software of system 100 and/or the CDS of the instrument being considered and/or calculated reduced data. The form may further include launch points for executables that perform detection, calculation, or any other functions called for by the process such as locating measurement data generated by the CDS that is stored in the CDS. The forms may be version controlled and stored as records of the data collection process leading to a resulting final report. In this way the stored versions of forms can serve as an audit trail from the time of initial collection of the data through to the time of the issuance of the final report.

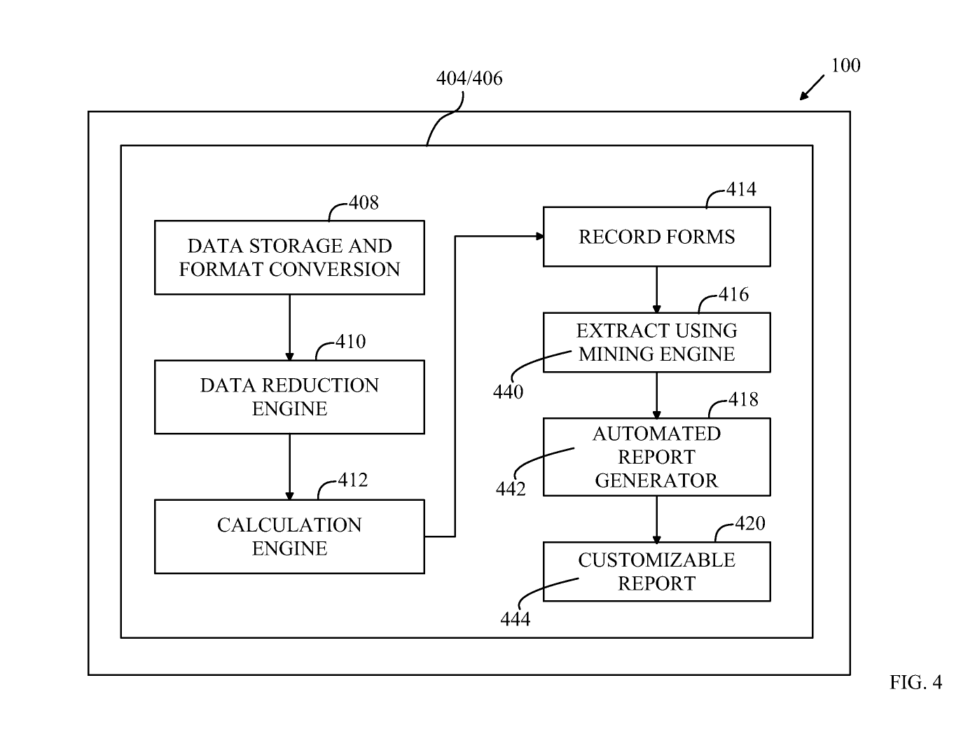

To manage data storage, metadata extraction and archival of data, as well as compilation of final reports and other form management functions, system 100 may employ an ECM. The ECM may provide a secure platform on which to manage these functions, and hence, provide a secure audit trail. FIG. 4 illustrates a flow chart of functions and processes that may be managed by an ECM 404 via business process manager (BPM) 406. BPM 406 manages flow so that data storage and format conversion are carried out by ECM 404 at event 408, followed by reprocessing/data reduction by data reduction engine at event 410. Further calculations are carried out by calculation engine 306 at event 412, which may be based upon instructions contained in the forms such as form 200, and the data populated into the forms may be recorded and stored in ECM 404 at event 414. The record forms may then be data mined at event 416 by record mining engine 440 to extract specific items of data/metadata that are required to populate a final report.

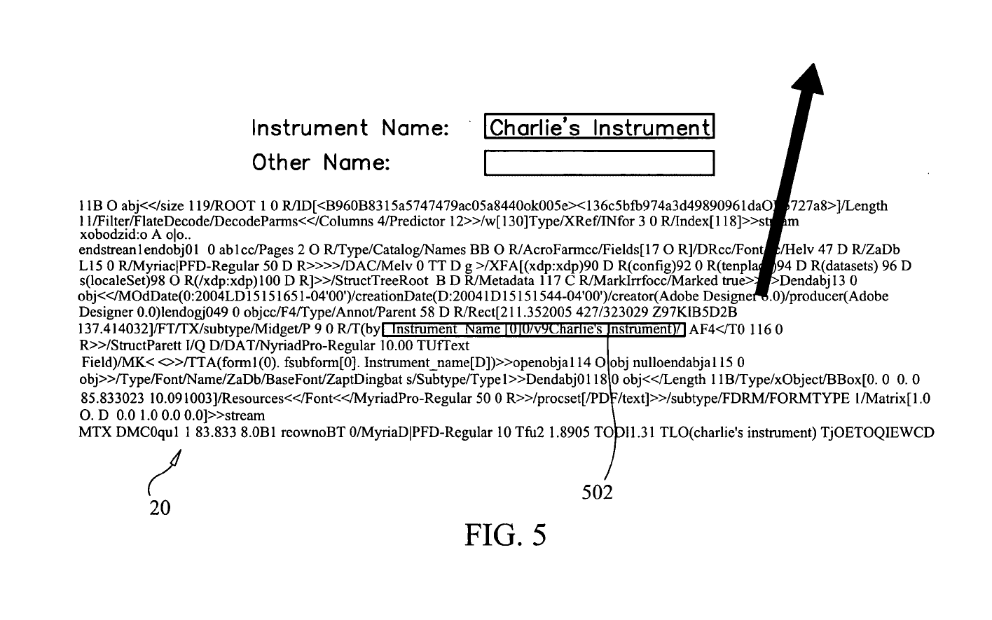

FIG. 5 illustrates data extraction from a form 200 to obtain information needed for preparing a report, wherein a portion of a form 200 is shown from which a particular data entry 502 is located. Record mining engine 440 may employ toolsets for mining data, e.g., name-value pairs may be taken from forms 200 and calculation engine 306 may further extract those values needed by identifying such values based upon the names associated with the values in the name-value pairs. Data from a form 200 can be calculated and the resulting calculations may be returned to the same form 200 or to another form 200 as needed for purposes of organization, readability, clarity, etc.

As shown, forms 200 contain the information/data received from the software of the instrument being considered, and that data can be mined to fill out automated report applications or otherwise to fill out a final report 444. In this way, forms 200 act as a repository that can be mined in various ways compliance, asset management, etc. Once a final report 444 is signed, however, the data that was mined to fill out the final report 444 can no longer be changed, ensuring inviolable metadata, so that an effective audit trail is maintained.

An automated report generator application 442 that functions to automatically populate documents at event 418 which are then outputted as a customizable final report 444 at event 420 may also be included. Automated report generator application 442 allows documents to be populated with content learned through many various mechanisms, such as the documentation associated with the CDS.

The automatically populated forms as well as the final report 444 may be stored in ECM 404 so that ECM 404 is the location of the initial collection, calculation, metadata and final data, as well as audit trails. Thus, system 100 may include a relational database that is accessed by tools such as data reduction engine 302, calculation engine 306, and record mining engine 440.

Final reports 444 can take on any form selected by a user. For example, a report may be created in summary form or in full detail, with or without a logo, etc. While the final reports 444 are customizable, in one aspect of the invention, the underlying forms created by the system 100 do not change so that standardization is preserved. Automated report generator application 442 may be provided whereby the user is provided with selectable choices, via user interface 250, to determine the format of the final report 444 to be produced. Thus, depending upon the selection made, different groupings of metadata from the underlying forms 200 are selected and combined into a format of the final form selected.

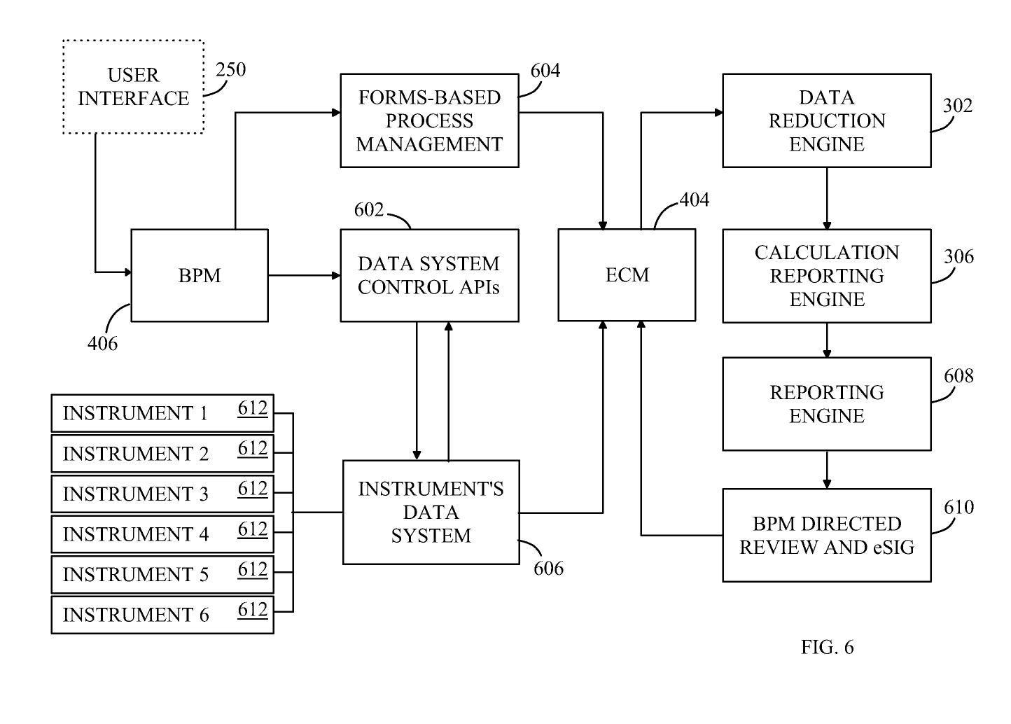

Referring now to FIG. 6, which is a flow chart that further explains process flow by the present invention. As noted above, a user interface is optional and may depend upon the choice of the user, the types of instruments being reported upon, and/or whether the system is capable of fully automatically obtaining all information required to generate a final report. System control APIs 602 are provided for running processes that do not need to be displayed on user interface 250. The BPM permits flexible formatting of process. For example, the process can be changed by interactively changing/rearranging a flow chart. For example, if a current process flow of system 100 includes a process or sub-process defined by steps A>>B>>C>>, but the current user/client requires step C to be performed after step A and before step B, then the current process chart can be interactively rearranged, such as by dragging step C between steps A and B to provide a process defined by the steps A>>C>>B. Accordingly, the system 100 provides a great amount of flexibility for customizing the process control, which is then managed by BPM 406 using forms-based process management 604 as was described earlier.

The technology neutral design of system 100 allows any client's or manufacturer's data system (i.e., Instrument's Data System 606) to be fed into ECM 404. Accordingly, any type of instrument, model of instrument or manufacturer of an instrument may be included as instruments 612 from which data can be received by system 100. For example, Instrument 1 may be a liquid chromatography/gas chromatography instrument 612 produced by a first manufacturer; Instrument 2 may be a liquid chromatography/gas chromatography instrument 612 produced by a second manufacturer, and Instrument 3 may be still another liquid chromatography/gas chromatography instrument 612 that is produced by a third manufacturer. Instrument 4 may be a “mixed vendor” system in which the underlying instrument is produced by one vendor and the CDS is produced by a different vendor.

The system can also accommodate different types of underlying instruments provided the technology neutral formatted data from these instruments is understood by the data reduction software. In one aspect of the invention, the technology neutral format includes information specifying the type of underlying instrument. Hence, a data storage form and report format(s) specific to the type of underlying instrument can be selected. For example, Instrument 5 may be a refrigerator with an embedded microprocessor, and Instrument 6 might be a centrifuge with a control processor.

As noted above, if the instrument's data is in a proprietary data format, the data is converted to technology neutral formatted data using system control APIs 602 or the data may be added to the forms manually. Both the proprietary data and the converted, technology neutral formatted data may be saved in ECM 404 to provide a reliable audit trail. The technology neutral formatted data can then be further processed by data reduction engine 302, calculation engine 306 and reporting engine 608. Reporting engine 608 may require a data mining application such as record mining engine 440 or a middleware component configured to provide an input file to reporting engine 608 to correctly populate a report.

Once final report 444 has been generated, BPM 406 can direct reviews and signatures electronically at event 610. The final report, both signed and unsigned may be stored in ECM 404. Further, all intermediate forms and the data that they store may be stored in ECM 404 to maintain a complete audit trail. All processing represented in FIG. 6 may be based on forms and the instructions contained therein. WYSIWYG authoring capability may be provided by the forms designer application for designing forms 200. Secure data handling is ensured by ECM 404.

The data path that the instrument 612 uses is the same data path that system 100 uses for reports such as compliance. However, the calculations performed on the data for whatever report is to be produced, do not need to be performed on the instrument itself, nor does the instrument's software need to be employed for performing calculations. Advantageously system 100 provides everything that is needed for performing such calculations. This effectively reduces the native CDS to a controller and data acquirer. Such reduction provides checks on the interplay between the hardware and software of a system to be qualified at each qualification event without burdening the hardware qualification event with data reduction evaluation of the native CDS. This ensures that the more frequent requirements for hardware qualification provide the maximum value with respect to CDS verification, without forcing extensive CDS evaluation. Further, the controlling system need not be qualified for use in the qualifying of hardware, since it is not used for such purpose by system 100. Rather, system 100 performs calculations on the raw data produced by the instrument (after conversion to a technology neutral format, if necessary), thereby taking the instrument's controlling software out of the loop and effectively separating the instrument's hardware, from the associated software, so that the report can focus on the hardware, independent of qualifying the instrument's controlling software.

In one aspect of the present invention, the data reduction system of the present invention is run on the CDS using an external memory device that contains the software of system 100. The software is preferably self-contained and leaves no data on the instrument system after the qualification operations have been completed. For example, the software of system 100 can be included in a form that does not depend on the operating system of the instrument system other than that operating system's ability to execute a self-contained program. In this case, any frameworks required by system 100 are included on the external memory device. When the qualification experiments are completed, the data is removed along with the software of system 100 such that the instrument system is left in the same state as when the qualification experiments were commenced. BPM 406 may control the workflow from collection of data through approvals/signatures of final report 444, and may be tightly integrated into ECM 404. The entirety of processing may be web browser-based or terminal servers-based so that no footprint is imposed upon the user's qualified computer. In instances where ECM 404 has been incorporated into a customer's system during the qualification process, local interfaces (e.g., user interface 250) may be employed. This aspect of the present invention ensures that the qualification runs do not alter the underlying instrument system.

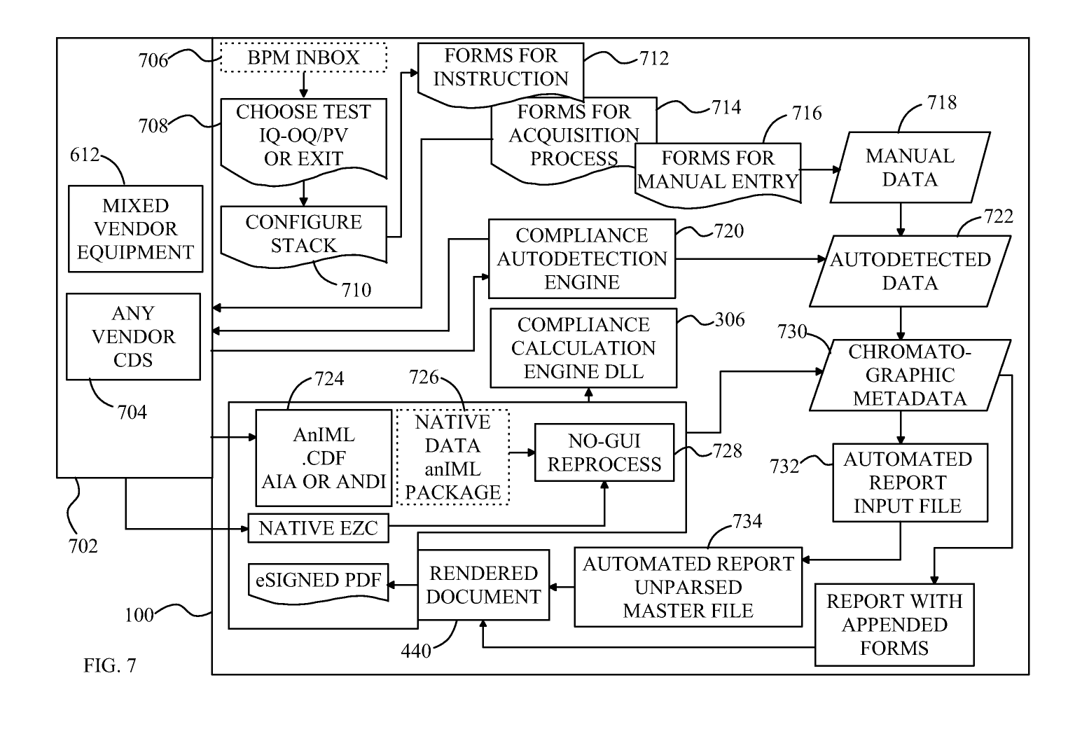

Referring now to FIG. 7, a more specific schematic representation of system 100 is shown for use in creating a compliance report for chromatographic instrumentation. System 100 is represented as interfacing 702 with native CDS to receive data inputs. In this example, the equipment being reported on is mixed vendor instrument 612, in which case, any or all of the vendor's computer data systems 704 may be employed through which data is inputted to system 100. Typically, however, a common data system controller is provided to control all of the mixed vendor modules. Forms 200 that are driven by BPM 406 may be presented to a user by placement into a user-specific inbox (BPM Inbox 706) that functions similarly to the inbox of an e-mail service. In this way, simple instructions can be provided in a “wizard” like environment. Thus, if a message is placed in BPM inbox 706 that instructs a simple task is to be performed, once the task is performed or “Done”, then the next task can be emailed or placed into BPM inbox 706. At event 708, a user, or manager assigning tasks to a user, may choose the type of test or qualification to be performed, In response to this choice BPM 406 may then run a template to call the correct forms to be completed for the chosen test. Configure stack 710 provides a configuration-specific template which determines the required tests, forms and instructions to be processed. Forms for Instruction 712 are one option for processing, herein these forms 200 associated with a qualification event may contain simple instructions for processing with no data entry potential. Forms for Acquisition Process 714 provide another option for processing according to forms associated with a qualification event in which forms 200 may describe the setup of the native data system to perform specific runs and acquire specific data from the instrument and/or software to be qualified.

Those same forms 200 may provide controls for entry (which may be manual and/or automated) of the results obtained from the processes run with respect to the native CDS to obtain the specific data. Forms for Manual Entry 716 are forms 200 in which manual entry may be made directly to. Alternatively, entry may be made to these forms 200 via an application supplied user interface when required by a system being tested. Manual data 718 refers to a further embodiment of forms 200 that may be created such that form elements are present to allow manual, interactive entry of data from an attendant user. Forms may also be constructed as a mixed model where some elements of the forms are automatically filled in when the data is available to the system. When data is not available to the system for automatically filling in the forms, such data can be manually supplied by the user.

Compliance auto-detection engine 720 may be an applet very similar to calculation engine 306 that stores or accesses identifying characteristics regarding various types, manufacturers, etc. of equipment. So for example, where a form requests a model number and serial number of an instrument 612, rather than requiring a user to manually enter this information, auto-detection engine 720 queries the CDS 704 associated with the piece of instrument 612 to obtain the required information and then automatically enters it into the form 200 from which the request originated. If auto-detection engine 720 is unsuccessful in automatically retrieving some or all of the query information, system 100 leaves the entries for this information on the applicable forms 200 blank and presents the forms for manual completion.

Data storage and format conversion of the inputted data are performed by ECM 404 as controlled by BPM 406 in accordance with the instructions contained in forms 200 selected by BPM 406 for processing the data, wherein forms 200 identify the particular data that is needed. In this example, data is converted to AnIML formatting 724 or other common data form (CDF), such as AIA (Analytical Instrument Association) or ANDI (Analytical Data Interchange) format (typically annotated with .cdf extensions), using Native Data AnIML package 726.

Once converted to a technology neutral format, data reduction engine 302 may perform reprocessing of the data in accordance with the needs of the final report to be generated, as instructed by the forms 200 as guided by BPM 406. Reprocessing/data reduction calculations can be can be driven by an API, so that no user interface is required (i.e., No-GUI Reprocess 728). Thus, data can be inputted directly from an instrument's computer data system 704 to system 100 where it may be converted to a technology neutral format and then fed directly to data reduction engine 302.

The reduced/reprocessed data is forwarded to calculation engine 306 for further calculations that are instructed by forms 200. In this example, calculations are performed for a compliance report, and calculation engine 306 is referred to as a compliance engine. Calculation engine 306 may mine forms 200 that have been populated by the reprocessing by data reduction engine 302, or may obtain data from mining results based on matching names to name-value pairs, perform the instructed calculations, and, together with the reprocessed data, output metadata 730, which is chromatographic metadata in this example. This processing may also be API driven, so that all processing may be carried out in the background, without interrupting a user for interactive input.

However, even if all the automation cannot work as intended, (such as when an instrument lacks adequate software or other capability for automatically interacting with system 100, for example) system 100 may launch user interface 250 to accept some interactive input from a user. In one aspect of the invention, even the calculation engine 306 is designed to work as an API. However, a user interface 250 may also be provided for calculation engine 306 to allow a user to use it as a custom calculator. For example, the same results can be manually calculated.

The manual data 718, auto-detected data 722 and metadata 730 may require some additional manual entry or entries depending upon the particular instrument from which data is being obtained. Examples of metadata entries that may need to be entered manually include, but are not limited to results of data collected from a source other than the data source provided by the native CDS, such as readings from onboard sensors, readings from external measurement devices, etc. Forms 200 that contain the manual data 718, auto-detected data 722 and metadata 730 are mined for the specific data required by the final report 444 to be created (such as by using record mining engine 440), and the mined data may be forwarded to an automated report generator application 442 that assembles the mined data into an automated report input file 732 which is forwarded to an unparsed master file 734, from which the automated report application renders the final report 444.

Alternatively, an automated report application need not be implemented. For example, final reports may be embodied by completed forms 200 without the need to data mine such forms. In addition, a final report may be compiled by mined data that is simply assembled and attached to the forms 200 containing metadata. Everything between the raw data (e.g., original data received from an instrument or instrumentation software) and the final reported values is considered metadata. Metadata may be raw data or mined data or a combination thereof as it is used to populate a form. Some pre-final data may already be provided on a form while additional pre-final data may need to be added by the process. The data on the forms 200 can all be considered metadata in the sense that it is used to create the final report data so it qualifies as data about the final report data.

To provide a secure audit trail, BPM 406 may then forward the final document, such as via e-mail, to have the final document (which may be in PDF format, as in the example shown in FIG. 7) signed. The final report cannot be modified by those reviewing it, but must be reprocessed by the system 100 if changes are to be made. The process flow for such a rerun or re-evaluation involves returning the process to the step that begins processing the information that is desired to be re-evaluated. However, if this is not done, then any changes will still be captured by ECM 404 through its automatic audit trails functionality. Further, BPM 406, together with ECM 404 may track the review process and store copies of the records to maintain the chain of the audit trail. The final report 444 is thus a defensible document for use in meeting compliance regulations.

Forms 200 can provide the basis for processing data by system 100. Wizard-like central data collection may be provided wherein either the automated client or a user are provided with simple tasks to complete by filling in the appropriate data. These tasks may require the automated client to query the instrument's software for the data which is then inputted to the form, or to perform calculations on select technology neutral data having been converted from the native data received from the software of the instrument. In their most basic configuration, forms 200 are provided to generate a customer deliverable, typically a final report containing specifically requested or required data. Thus, forms 200 with standard defaults may be provided to automatically generate such a final report.

Further, forms 200 stored in ECM 404 may be configured to function as an audit trail by storing versions of the forms as they are completed, together with data and time stamp, for example. Further, forms 200 may be configured to contain instructions for all processing by system 100. For example, certain forms 200 may contain specific instructions for calculations to be performed by calculation engine 306. Thus, forms 200 can be interactively filled out by a user through user interface 250, and/or can be programmatically filled out by auto-detection processes or calculation engines.

Various combinations of forms 200, automation and custom reporting may constitute a final report by system 100. Using ECM 404 together with forms 200, forms 200 along with the final report 444 may be centrally stored and provide an audit trail for support of the final product. By adding the automated calculation engines, such as data reduction engine 302, calculation engine 306 and records mining engine 440, processing may be fully automated to provide a final report, if only according to a defaulted form of the final report 444. Adding the automated report generator application 442 provides further flexibility, whereby a final report 444 can be customized. The modules need not be combined as described above. For example, forms 200 may be combined only with automated report generator application 442, so that a final report 444 generated from manual inputs to forms 200 may be customized using the automated report generator application 442.

Further, a hierarchy of forms 200 may be provided for more efficient completion of forms 200 during processing. For example, a master form may be set up to feed other process forms: A master form generally contains information that is globally the same with respect to all process forms that it feeds. Accordingly, this permits that global information to be filled out only once, after which it automatically appears in all of the subordinate forms 200 fed by that master form 200. Different types of master forms 200 may also be created. For example, a qualification master form 200 may contain global information such as customer information (address, names, etc.), instruments that a qualification will be covering, and/or acceptance limits for instrument categories. An instrument configuration master form 200 may contain a named configuration mapped to configuration details (e.g., a stack of instruments 612) and/or override limits for specific equipment needs. A stack, for example, may include all of one type of instrument, different vendors' instruments, or any combination of instruments, as the complexity of the stack can be programmed into an instrument configuration master form 200. Instrument configuration master forms 200 may be limited to only those instruments and vendors that are configuration master approved, to prevent a user from arbitrarily attempting to add an instrument to an instrument configuration master form for which there is no procedure for processing.

Using the methods and systems described herein, non-vendor specific instrument qualifications may be processed using a native controlling software of an instrument combined with a technology neutral, standardized, post-collection data reduction and reporting model. Original data collected for the qualification may be accomplished using the native controlling software without the need to go through external analog-to-digital conversion or other manipulation. However, system 100 is not precluded from using alternative data input methods, including, but not limited to data that has already been digitized; manual input of data, etc. Original data may be preserved for possible reanalysis by the native controlling software, and may also be converted to an accepted technology neutral format allowing the data to be submitted to a single reprocess and calculation engine for consistent reduction and processing. Forms may be presented according to need and apply only to the instrument under test to reduce delivery complexity and error while providing audit trails for tracking.

The ECM used to provide the storage and processing of the data for generating qualification reports can be owned by the organization that owns the instrument being qualified by an independent organization. The use of an ECM belonging to a party who is not controlled by the owner of the system that is being qualified ensures that the final qualification reports provide acceptable evidence of the performance of the equipment in legal or other proceedings that are commenced years after the qualification tests in question.

The present invention also includes a computer readable medium that stores instructions that cause a data processing system to execute the method of the present invention. A computer readable medium is defined to be any medium that constitutes patentable subject matter under 35 U.S.C. 101 and excludes any medium that is not patentable subject matter under 35 U.S.C. 101. Examples of such media include non-transitory media such as computer memory devices that store information in a format that is readable by a computer or data processing system.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular hardware, software, instrument, module, process, process step or steps, to the objective, spirit and scope of the present invention. All such modifications are intended to be within the scope of the claims appended hereto.

What is claimed is:

1. A method for operating a data processing system to perform compliance testing of an instrument system that includes an underlying instrument and a computerized data system (CDS) that controls said underlying instrument, said method comprising:
causing data indicative of a measurement made on a test sample by said underlying instrument to be received by said data processing system;
performing one or more data reduction computations on said received data while said received data is in a technology neutral format using said data processing system to generate one or more outputs in a technology neutral format; and
generating a final report in a technology neutral format with said one or more outputs.

2. The method of claim 1 wherein said data processing system is a program operating on said CDS.

3. The method of claim 1 wherein said received data is received in a native format and converted to said technology neutral format by said data processing system before said data reduction computations are performed.

4. The method of claim 1 wherein said CDS converts said data indicative of said measurement to a technology neutral format prior to said data indicative of said measurement being received by said data processing system.

5. The method of claim 1 wherein said data processing system comprises a program that runs on said CDS.

6. The method of claim 1 wherein said data processing system operates said underlying instrument to make said measurement without utilizing said CDS to make said measurement.

7. The method of claim 1 wherein said final report includes security features that prevent said final report from being altered after said final report is approved by a predetermined entity.

8. The method of claim 1 wherein said instrument system is owned by a first party and wherein said data processing system is provided by a second party that is different from said first party.

9. The method of claim 8 wherein said final report is stored on an enterprise content manager that is owned by said second party.

10. The method of claim 1 wherein said final report establishes compliance with a standard promulgated by a governmental regulatory agency.

11. A computer readable medium comprising instructions that cause a data processing system to execute a method for performing compliance testing of an instrument system that includes an underlying instrument and a CDS that controls said underlying instrument, said method comprising:
causing data indicative of a measurement made on a test sample by said underlying instrument to be received by said data processing system;
performing one or more data reduction computations on said received data while said received data is in a technology neutral format using said data processing system to generate one or more outputs in a technology neutral format; and
generating a final report in a technology neutral format with said one or more outputs.

12. The computer readable medium of claim 11 wherein said data processing system is a program operating on said CDS.

13. The computer readable medium of claim 11 wherein said received data is received in a native format and converted to said technology neutral format by said data processing system before said data reduction computations are performed.

14. The computer readable medium of claim 11 wherein said CDS converts said data indicative of said measurement to a technology neutral format prior to said data indicative of said measurement being received by said data processing system.

15. The computer readable medium of claim 11 wherein said data processing system comprises a program that runs on said CDS.

16. The computer readable medium of claim 11 wherein said data processing system operates said underlying instrument to make said measurement without utilizing said CDS to make said measurement.

17. The computer readable medium of claim 11 wherein said final report includes security features that prevent said final report from being altered after said final report is approved by a predetermined entity.

18. The computer readable medium of claim 11 wherein said instrument system is owned by a first party and wherein said data processing system is provided by a second party that is different from said first party.

19. The computer readable medium of claim 18 wherein said final report is stored on an enterprise content manager that is owned by said second party.

20. The computer readable medium of claim 11 wherein said final report establishes compliance with a standard promulgated by a governmental regulatory agency.
